(19) United States
(12) Patent Application Publication
(10) Pub. No.: US 2019/0000713 A1
(43) Pub. Date: Jan. 3, 2019

(54) CONTAINER SUCH AS A BLISTER PACK

(71) Applicant: Essentra Packaging & Security Limited, Nottinghamshire (GB)

(72) Inventor: Tony KELLY, Nottingham, Nottinghamshire (GB)

(21) Appl. No.: 16/064,709

(22) PCT Filed: Dec. 21, 2016
(86) PCT No.: PCT/GB2016/054023

§ 371 Date: Jun. 21, 2018

(30) Foreign Application Priority Data
Dec. 21, 2015 (GB) 1522499.1

(51) Int. Cl. A61J 1/03; B65D 75/36; B65D 75/54; B65B 5/02

(52) U.S. Cl. CPC A61J 1/035; B65D 75/367; B65D 75/54; B65D 2575/368; A61J 2205/20; A61J 2205/30; B65B 5/02

(57) ABSTRACT

A container including a panel which defines one or more pockets in the surface thereof, wherein the one or more pockets are for holding a product; a closure layer disposed on the panel for sealing the product in the pocket(s); and a peelable label disposed on the closure layer. The peelable label has a first portion and a second portion, wherein the first portion of the peelable label is permanently secured to the closure layer or the panel, and the second portion of the peelable label is releasably adhered to the closure layer.

The present invention relates to containers for products, such as blister packs.

A blister pack is a common type of container for goods, such as small consumer products, food products and pharmaceutical products. A blister pack usually includes a preformed plastic packaging defining one or more pockets. The pockets contain a product and are sealed by a closure layer. To dispense the product the user applies pressure to the pocket and product therein to thereby push the product through the closure layer. Blister packs are useful for protecting products against external perturbations, such as moisture, sunlight, and bacterial or other contamination. Blister packs also provide a degree of tamper resistance and tamper evidence.

In many countries, blister packs are used as unit dose packaging for pharmaceutical products, such as tablets, capsules and the like. Blister packs used for storing pharmaceutical products are typically provided in a box, along with a separate information insert. The information insert typically includes information on dosage and safety, and is typically provided as a folded paper leaflet. These folded paper leaflets can be fiddly, cumbersome and easily mislaid. The closure layer of the blister pack may be provided with printed text, but there is usually limited space for this, and it can be difficult to print on some commonly used closure layer materials. Thus, there is a need for a simple and effective means of providing branding, product information, safety information and the like in packaging for products, such as pharmaceutical products, that are contained in blister packs.

The backing of the blister pack is typically brittle to allow the material contained in the pocket (for example a pharmaceutical product) to be dispensed by applying pressure to the back of the pocket to push the material through the closure layer. While this provides a simple and effective means for a user to dispense a product from the blister pack, the closure layer is liable to damage, for example, during transit or by the user. Damage to the backing could render the product within the pocket unusable. Thus, there is a need for a blister pack, in which the contained product can easily be dispensed, while the closure layer is resistant to damage.

In a first aspect of the present invention, there is provided a container comprising:
a panel, defining one or more pockets in the surface thereof,
   wherein the one or more pockets are for holding a product (for example hold a product);
a closure layer disposed on the panel for sealing the product in the pocket(s); and
a peelable label disposed on the closure layer, the peelable label having a first portion and a second portion,
   wherein the first portion of the peelable label is permanently secured to the closure layer or the panel, and the second portion of the peelable label is releasably adhered to the closure layer.

The applicant has found that a peelable label that is releasably adhered to the closure layer allows, for example, additional information to be conveniently provided on the container. The peelable label may be printed. For example, the underside of the peelable label (i.e.

that is adhered to the closure layer) may be printed with, for example, safety information and/or branding and the like. Furthermore, the upper (outer) surface of the peelable label may be printed. For example, the outer surface of the peelable label may be printed with information, graphics, branding and the like.

Providing a peelable label releasably adhered to the closure layer may negate the need to provide a separate medicine information insert, or may allow such an insert to be reduced in size. Separate medicine information inserts can be bulky, fiddly to read and easily misplaced. According to this aspect of the invention, the information may be provided on the peelable label and thus attached to the container, which means that it stays with the product and is unlikely to be misplaced. The peelable label may also provide additional protection for the closure layer and hence the product inside the pocket, for example the peelable label may prevent accidental fracture of the closure layer.

Having the first portion permanently secured to the closure layer or the panel, and the second portion releasably adhered to the closure layer provides a simple and effective container, in which, in use, the peelable label may be partially removed to reveal, for example, printed information, and to access the product inside the pocket. Once the product within the pocket is dispensed, the label can be easily readhered to the closure layer. The first portion of the peelable label being permanently secured to the closure layer or the panel means that the first portion will remain secured to the closure layer or the panel during normal use.

Preferably, the first portion of the peelable label is permanently secured to the closure layer. In other examples, it will be appreciated that the closure layer may be permanently secured to the panel, if for example, the closure layer does not cover the entirety of the panel.

Herein, the term “releasably adhered” includes the meaning in which, for example, a first substrate has the ability to adhere to a second substrate and then be easily removed from the second substrate, without substantially damaging the first substrate.

Preferably, the second portion of the peelable label is resealable. This means that the second portion of the peelable label may be removed from the surface of the closure layer and then readhered to the surface of the closure layer multiple times, while the second portion of the peelable label does not suffer a substantial reduction in adhesiveness.

The peelable label may comprises paper, a polypropylene film, a metallised polypropylene film, a polyethylene film, a co-polymer or any other suitable material known in the art.

The peelable label may comprise a laminate having a lower layer and an upper layer. A multilayer laminate, for example a two layer laminate, enables reverse print on the lower layer to be sealed.

A first portion of the lower layer may be permanently secured to the panel or the closure layer, for example to the closure layer, and a second portion of the lower layer may be releasably adhered to the closure layer. The peelable label may include a layer of permanent lamination adhesive disposed between the upper layer and the lower layer to effect lamination of the two layers. The upper layer may comprise paper, a polypropylene film, metallised polypropylene film, polyethylene film, a co-polymer or any other suitable material known in the art. The upper layer may have a thickness from 30 to 90 μm, for example 50 μm. The lower layer may comprise paper, a polypropylene film, polyethylene film, a co-polymer or any other suitable material known in the art. The lower film may have a thickness from 30 to 90 μm, for example 50 μm. The permanent lamination adhesive may be any suitable permanent lamination adhesive known in the art, for example a solvent based acrylic adhesive, a water based acrylic adhesive, hot melt adhesive or a UV cured adhesive. The upper layer and/or the lower layer may be printed. An upper film comprising metallised polypropylene may advantageously increase the opacity of the label, making it easier to read the information printed on the label.

The second portion of the peelable label may be releasably adhered to the closure layer by means of a resealable adhesive disposed on the surface of the second portion, for example disposed on the underside of the second portion. Alternatively, a permanent adhesive may be disposed on the surface of the second portion, the permanent adhesive being selectively printed or coated such that the second portion of the peelable label is releasably adhered to the closure layer, and the permanent adhesive effectively functions as a resealable adhesive. If the peelable label comprises a laminate, then the second portion of the peelable label may be releasably adhered to the closure layer by means of a layer of resealable adhesive disposed on the underside of the lower layer. Alternatively, a permanent adhesive may be disposed on the underside of the lower layer, the permanent adhesive being selectively printed or coated such that the second portion of the peelable label is releasably adhered to the closure layer, and the permanent adhesive effectively functions as a resealable adhesive.

The first portion of the peelable label may be permanently secured to the closure layer or the panel (for example the closure layer), by means of a layer of permanent adhesive disposed on the surface of the first portion, for example disposed on the underside of the first portion. If the peelable label comprises a laminate, then the first portion of the peelable label may be permanently secured to the closure layer or the panel (for example, the closure layer) by means of a layer of permanent adhesive disposed on the underside of the lower layer.

The resealable adhesive may be any suitable resealable adhesive known in the art, for example, a water based acrylic adhesive, a solvent based acrylic adhesive, a pressure sensitive adhesive, or a hot melt adhesive.

The permanent adhesive may be any suitable permanent adhesive known in the art, for example a water based acrylic adhesive, a solvent based acrylic adhesive, a pressure sensitive adhesive, a hot melt adhesive, or a UV cured adhesive.

Preferably, the peelable label comprises a hinge substantially in register with the junction between the first portion and the second portion. The applicant has found that providing a hinge helps to prevent the peelable label from springing back towards the closure layer after the peelable label is partially removed, so making it easier for the user to remove material from the pocket. The hinge may be in the form of a crease that is substantially in register with the junction between the first portion and the second portion. A crease is a simple solution for providing a label which does not spring back towards the closure layer when the label is partially removed during use. If the peelable label comprises a laminate, having for example an upper layer and a lower layer, then the hinge may comprise a cut in the lower layer substantially in register with the junction between the first portion and the second portion.

The peelable label may comprise a dead fold film. If the peelable label comprises a laminate having, for example, an upper layer and a lower layer, then the lower layer may comprise a dead fold film. The inclusion of a dead fold film in conjunction with a crease or a cut in the lower layer, may further help to prevent the label from springing back towards the closure layer after the peelable label is partially removed. A dead fold film is a film that has a dead fold property, that is the property of a film to retain a fold and not unfold spontaneously.

The peelable label may comprise a finger lift tab. This may be in the form of a portion of the peelable label that may be easily grasped by the user. For example, the finger lift tab may be positioned in the corner of the peelable label. The finger lift tab may be deflected from the plane of the peelable label, for example the finger lift tab may be in a raised configuration. The finger lift tab may be substantially free of resealable adhesive such that it does not adhere to the closure layer or other objects. Alternatively, if the finger lift tab is not substantially free of resealable adhesive, it may include an adhesive deadening layer disposed on the resealable adhesive in the region of the finger lift tab.

Having a finger lift tab makes it easier for the user to grasp the peelable label to partially remove the peelable label during use. The peelable label may include a crease (or a further crease) that defines the finger lift tab and causes the fingerlift tab to be deflected from the plane of the peelable label, and remain deflected. The peelable label may comprise a dead fold film extending over the finger lift tab. The dead fold film may comprise a cellulosic film. A dead fold film may help to enable the finger lift tab to remain in a deflected configuration.

The peelable label may comprise one or more peelable layers.

The peelable label may comprise a base layer and a peelable upper layer, wherein the peelable upper layer is releasably adhered to the base layer, and wherein the base layer comprises a first portion that is permanently secured to the closure layer or the panel, and a second portion that is releasably adhered to the closure layer.

The first portion of the base layer may be permanently secured to the closure layer or the panel by means of a layer of permanent adhesive disposed on the surface of the first portion of the base layer, for example disposed on the underside of the first portion of the base layer. The second portion of the base layer may be releasably adhered to the closure layer by means of a layer of resealable adhesive disposed on a surface of the second portion of the base layer, for example disposed on the underside of the second portion of the base layer.

The peelable upper layer may comprise a first portion and a second portion, wherein the first portion of the peelable upper layer may be permanently secured to the first portion of the base layer, and the second portion of the peelable upper layer may be releasably adhered to the second portion of the base layer.

The first portion of the peelable upper layer may be permanently secured to the base layer by means of a layer of permanent adhesive disposed on the surface of the first portion of the peelable upper layer, for example disposed on the underside of the first portion of the peelable upper layer. The second portion of the peelable upper layer may be releasably adhered to the base layer by means of a layer of resealable adhesive disposed on the surface of the second portion of the peelable upper layer, for example disposed on the underside of the second portion of the peelable upper layer. Alternatively, a layer of permanent adhesive may be disposed on the underside of the second portion of the peelable upper layer. The top surface of the second portion of the base layer may be provided with a release coating to thereby cause the second portion of the peelable upper layer to be releasably adhered to the second portion of the base layer.

The second portion of the base layer and the second portion of the peelable upper layer may be resealable.

The peelable upper layer may be printed. For example, the underside of the peelable upper layer (for example, the surface that may be adhered to the base layer) may be printed with, for example, safety information and/or branding and the like. The upper (outer) surface of the peelable upper layer may be printed. For example, the upper surface of the peelable upper layer may be printed with information, graphics, branding and the like.

The base layer may be printed. For example, the underside of the base layer (for example, the surface that may be adhered to the closure layer) may be printed with, for example, safety information and/or branding and the like. The upper (outer) surface of the base layer may be printed. For example, the upper surface of the base layer may be printed with information, graphics, branding and the like.

In use, a user may grasp the peelable upper layer and remove or partially remove the peelable upper layer from the base layer to reveal, for example, safety information printed on the base layer and printed on the underside of the peelable upper layer. The user may then grasp the base layer and partially remove the base layer from the closure layer to allow the user to access the product within the pocket. This may also reveal information that may be printed on the underside of the base layer. Once the product within the pocket is dispensed, the base layer can be re-adhered to the closure layer, and the peelable upper layer can be re-adhered to the base layer.

The peelable upper layer and/or the base layer may comprise a hinge substantially in register with the junction between the first portion and the second portion.

The peelable upper layer and the base layer may comprise a single layer or a laminate as described above.

The peelable label may further comprise one or more additional layers (e.g. peelable layers) positioned between the base layer and the peelable upper layer. This configuration may enable additional information to be included within the peelable label.

Each additional layer may include a first portion and a second portion. The first portion of each additional layer may be permanently secured to the first portion of another layer. For example, the first portion of a first additional layer may be permanently secured to the first portion of the base layer, and permanently secured to the first portion of a second additional layer. The first portion of the second additional layer may be permanently secured to the first portion of the peelable upper layer.

The first portion of the one or more additional layers may be permanently secured to a first portion of another layer by means of a layer of permanent adhesive.

The second portion of each additional layer may be releasably adhered to the second portion of another layer. For example, the second portion of a first additional layer may be releasably adhered to the second portion of the base layer, and releasably adhered to a second portion of a second additional layer. The second portion of the second additional layer may be releasably adhered to the second portion of the peelable upper layer.

The second portion of the one or more additional layers may be releasably adhered to a second portion of another layer by means of a layer of resealable adhesive.

Alternatively, the second portion of the one or more additional layers may not be releasably adhered to another layer. In this configuration, the second portion of the one or more additional layers may remain adhesive free or comprise an adhesive deadening layer disposed on top of the layer of resealable adhesive. The peelable upper layer and base layer may extend beyond the one or more additional layers to enable the peelable upper layer to adhere to the base layer.

The peelable label may comprise, for example, up to 6 additional layers positioned between the base layer and the peelable upper layer.

The peelable label may further comprise a folded leaflet adhered to the peelable upper layer and/or the base layer. A peelable label which includes a folded leaflet enables additional information to be included within the peelable label.

Preferably, the closure layer is a foil, for example a metallic foil, for example an aluminium foil. The closure layer should seal the pocket to, for example, protect the product in the pocket. A metallic foil, provides an effective seal when the container is not in use, for example during transit. A metallic foil also provides a degree of tamper evidence and tamper resistance. A metallic foil may also be sufficiently brittle to allow for the product in the pocket to be dispensed easily in use, for example by pushing the product through the foil.

The closure layer (e.g. metallic foil) may be printed with for example, branding and information.

Preferably, the one or more pocket(s) is collapsible. This enables a product in the pocket (for example a pharmaceutical product, for example a tablet) to be pushed through the closure layer (e.g. metallic foil) by applying a force to the outside of the pocket to thereby force the product through the closure layer (e.g. metallic foil).

The panel may defines a plurality of pockets.

The one or more pocket may each contain for example, a pharmaceutical product, a food product, a nutritional supplement, a veterinary product, a consumer product or a small component, e.g. screws, fuses and the like.

The one or more pockets may each contain a pharmaceutical product, for example in the form of a tablet, a pill, a capsule, caplet, a lozenge, a powder, a liquid, a gel, a cachet, and the like.

In a further aspect of the present invention there is provided a use of a container as set out above for storing a pharmaceutical product.

In a further aspect of the present invention there is provided a container comprising:
a blister pack; and
a peelable label having a first portion and a second portion disposed on the blister pack,
   wherein the first portion of the peelable label is permanently secured to the blister pack, and the second portion of the peelable label is releasably adhered to the blister pack.

In a further aspect of the present invention there is provided a method for making a container comprising:
forming a blister pack comprising a panel, defining one or more pockets in the surface thereof, wherein the one or more pockets hold a product; a closure layer disposed on the panel for sealing the product in the one or more pockets;
forming a peelable label having a first portion and a second portion;
adhering the peelable label to the closure layer, such that the first portion is
permanently secured to the panel or the closure layer, and the second portion is releasably adhered to the closure layer.

The blister pack may be formed by:
forming a panel, defining one or more pockets in the surface thereof;
dispensing a product in to the one or more pockets;
forming a closure layer;
adhering the closure layer to the panel to thereby seal the product in the one or more pockets.

In a further aspect of the present invention there is provided a container substantially as described herein with reference to the accompanying drawings.

Preferred embodiments of the present invention will now be described, by way of example only, with reference to the accompanying drawings, in which:

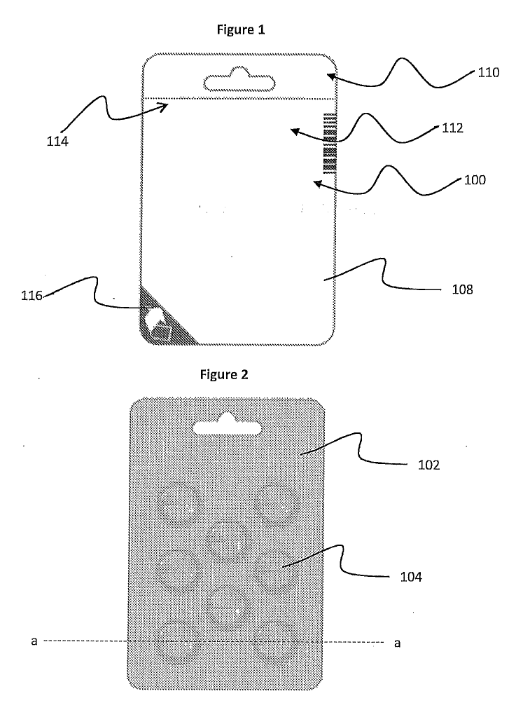

FIG. 1 is a top view of the container.

FIG. 2 is a bottom view of the container.

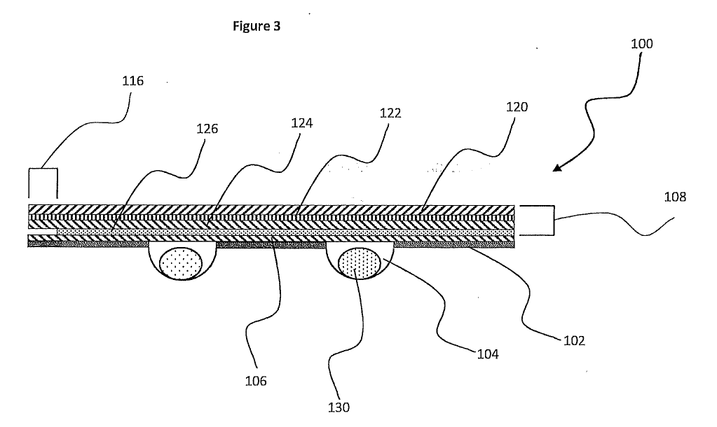

FIG. 3 is a sectional view of the container along line a-a in FIG. 2.

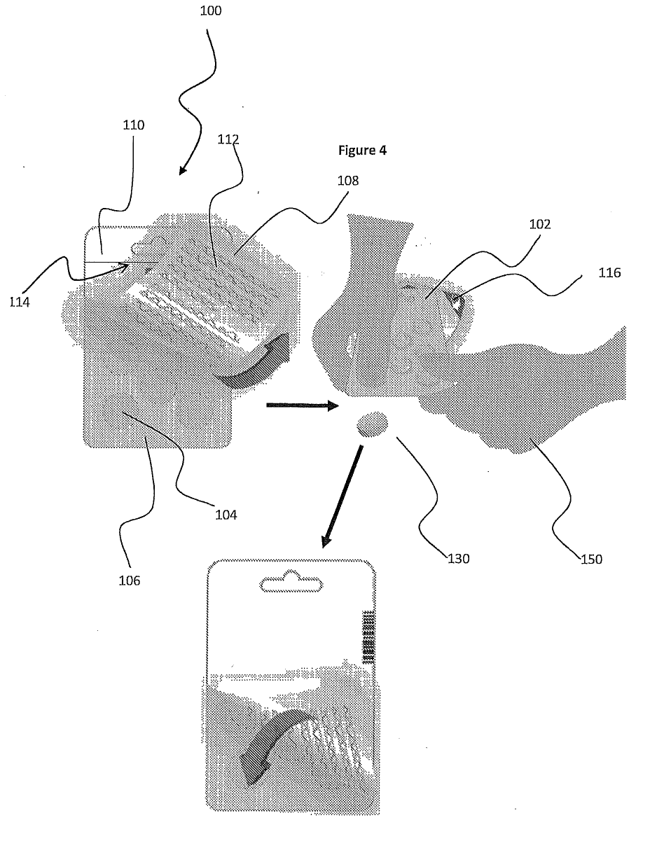

FIG. 4 is a schematic view of the container in use.

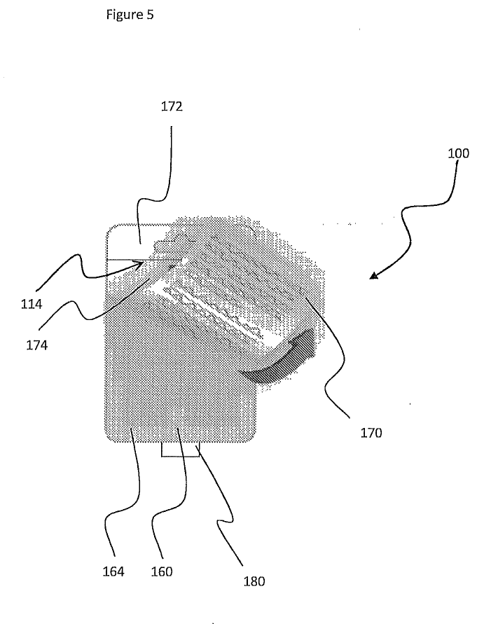

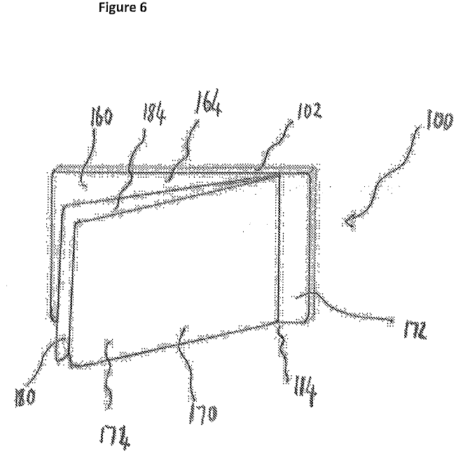

FIG. 5 is a perspective view of a container in use.

FIG. 6 is a perspective view of a container in use.

FIGS. 1 and 2 show a top view and a bottom view respectively of an example of the container 100 according to the present invention.

The container 100 has a panel 102, defining a plurality of pockets 104. The panel is made from a thermoformed plastic material, such as PVC, and has a rectangular shape, although it will be appreciated that in other examples alternative shapes may be used. The panel includes a hole, through which a hook can pass, so that the container can be stored by hanging, in for example, a shop or pharmacy. The pockets 104 are hemispherical, and are formed in the panel. The pockets contain a product, for example a pharmaceutical product. The walls of the pockets 104 are made from the same material as the panel 102 (for example, a thermoformed plastic material), but the walls are thinner than the rest of the panel 102, so that the pockets are deformable and collapsible. This enables the product in the pocket 104 to be easily dispensed, as is explained below with reference to FIG. 4.

A closure layer (not shown) of, for example an aluminium foil, is disposed on top of the panel 102 to seal the product within the pockets 104. A peelable label 108 is adhered to the closure layer. The peelable label 108 has a first portion 110 and a second portion 112. The first portion 110 of the peelable label 108 is permanently secured to the closure layer by means of a layer of permanent adhesive disposed on the underside of the first portion. The permanent adhesive may be any suitable permanent adhesive known in the art. The second portion 112 is releasably adhered to the closure layer by means of a layer of resealable adhesive disposed on the underside of the second portion. The resealable adhesive may be any suitable resealable adhesive known in the art. The peelable label 108 comprises a hinge in the form of a crease 114 that is positioned substantially in register with the junction between the first portion 110 and the second portion 112 of the peelable label 108. The crease helps to prevent the label from snapping back when the label is partially removed from the closure layer during use. The peelable label 108 also includes a finger lift tab 116, positioned in the corner of the second portion 112 at the opposite end of the label to the first portion. The finger lift tab 116 is shown in a flat configuration, but it may be deflected from the plane of the peelable label 108, i.e. it may exist in a raised configuration. The finger lift tab 116 is free of adhesive, so the finger lift tab 116 does not adhere to the closure layer (or other surfaces) and can be easily grasped by the user, in use, to partially remove the peelable label 108. The peelable label 108 is printed on the top surface with for example branding, barcodes, and information about the product contained within the container. Printing may also indicate the position of the finger lift tab 116 to aid the user. The peelable label 108 may also be printed on the underside (not shown), so that when the peelable label 108 is partially removed in use, printed material, for example, information becomes visible.

FIG. 3 shows a section of the container 100 along the line a-a in FIG. 2.

The container 100 includes a panel 102 that forms the base of the container 100. The panel 102 defines two pockets 104, that have walls that are thinner than the rest of the panel 102. Within each pocket is a pharmaceutical product 130, for example a tablet. A closure layer 106 is disposed on top of the panel and seals the pharmaceutical product within the pockets 104. The closure layer is in the form of a metallic foil, for example an aluminium foil. The closure layer 106 is secured to the panel 102 by means of a layer of permanent adhesive (not shown). Adhered to the closure layer 106 is the peelable label 108.

The peelable label 108 comprises a laminate structure, having an upper layer 120, a layer of permanent lamination adhesive 122, a lower layer 124 and a layer of resealable adhesive 126. The upper layer 120 is typically a metallised polypropylene film and has a thickness from 30 to 90 μm. The upper layer 120 may be printed with graphics and text to represent, for example, branding, the product in the container, and product warnings. The layer of permanent lamination adhesive 122 is disposed between the upper layer 120 and the lower layer 124, and the permanent lamination adhesive 122 is a suitable permanent adhesive known in the art, for example a solvent based acrylic adhesive, a water based acrylic adhesive, hot melt adhesive a UV cured adhesive. The lower layer 124 typically comprises paper or a polymer film, such as a polypropylene film, polyethylene film a co-polymer and the like, and has a thickness from 30 to 90 μm. The lower layer 124 may be printed with, for example, text that is visible on the underside of the label, so that additional information can be provided on the label which is visible in use (i.e. when the peelable label is peeled back). The layer of resealable adhesive 126 is disposed on the underside of the lower layer 124 in the region of the second portion. As can be seen from FIG. 3, the underside of the lower layer 124 is free of resealable adhesive in the region of the finger lift tab 116, so that the finger lift tab 116 does not adhere to the closure layer 106 or other surfaces. It will be appreciated that in some embodiments, the underside of the lower layer in the region of the finger lift tab may not be free of resealable adhesive, in which case the finger lift tab may include an adhesive deadening layer disposed on the layer of resealable adhesive in the region of the finger lift tab. The resealable adhesive may be any suitable resealable adhesive known in the art. It will be appreciated that in some embodiments, the resealable adhesive may be in the form of a selectively printed or coated permanent adhesive that effectively functions as a resealable adhesive.

While not shown in FIG. 3 (because of the position of the cross section a-a in FIG. 2) it will be appreciated that in the region of the first portion, a layer of permanent adhesive is disposed on the underside of the lower layer 124 to secure the lower layer (and the peelable label) to the closure layer 106.

FIG. 4 illustrates the container 100 in use. In use, the finger lift tab 116 of the peelable label 108 is grasped by the user 150 and by application of a pulling force, the peelable label is partially removed from the closure layer 106, i.e. the peelable label is peeled back. As indicated by FIG. 4, the whole label is not removed; only the second portion 112 of the peelable label 108 is removed. The layer of permanent adhesive disposed on the underside of the first portion secures the label to the closure layer 106 and prevents the whole label being removed in use. The crease 114 acts as a hinge and prevents the peelable label 108 from springing back and covering the closure layer 106 and panel 102 when the user releases the peelable label 108 to dispense the pharmaceutical product 130.

As can be seen from FIG. 4, the underside of the peelable label is printed. For example, the underside of the label may include branding, product information, promotional material and the like. Containers for pharmaceutical products could include a peelable label in which the underside of the peelable label includes instructions or safety information, thus negating the need for additional information inserts or enabling such information inserts to be reduced in size. Furthermore, attaching important information to the container in this way may reduce the likelihood of the information becoming detached from the container and being misplaced.

Partial removal of the peelable label 108 allows access to the contents of the pockets 104, for example pharmaceutical product 130. The pharmaceutical product 130 is sealed in the pocket 104 by the closure layer 106, which is a metallic foil. The walls of the pocket 104 are deformable and collapsible, so the user 150 can apply force to the back of the pocket 104 and push the pharmaceutical product 130 through the metallic foil closure layer 106 to dispense the pharmaceutical product 130 from the container 100. The metallic foil closure layer 106 is sufficiently brittle to allow the pharmaceutical product 130 to be pushed through the closure layer 106.

After the pharmaceutical product 130 (or pharmaceutical products) is dispensed, the peelable label 108 may be re-adhered to the closure layer 106 by applying pressure to the peelable label 108 to effect contact of the peelable label 108 with the closure layer 106. The layer of resealable adhesive disposed on the underside of the peelable label 108, enables the peelable label to be readhered to the closure layer 106. The peelable label 108 may be partially removed and readhered many times without the peelable label 108 losing significant adhesiveness.

The panel and closure layer may be made and assembled by methods known in the art. A peelable label is made by methods known in the art. A peelable label is then applied to the closure layer by methods known in the art, such that the first portion of the peelable label is permanently secured to the closure layer and the second portion of the peelable label is releasably adhered to the closure layer. The peelable labels may be applied to the closure layer in a continuous process by methods known in the art, for example by hand or using an automatic labelling machine.

FIG. 5 illustrates a further example of a container 100. The container includes a panel (not shown), defining a plurality of pockets (not shown), and a closure layer (not shown), as described above. Adhered to the closure layer is a peelable label, having a first portion and a second portion. The peelable label shown in FIG. 5 comprises a base layer 160 and a peelable upper layer 170. The peelable upper layer 170 comprises a first portion 172 and a second portion 174. The base layer 160 comprises a first portion (not shown) and a second portion 164. The first portion and the second portion 164 of the base layer 160 are mutually coextensive with the first portion 172 and the second portion of the peelable upper layer 174. The peelable label includes a hinge in the form of a crease 114 that is positioned substantially in register with the junction between the first portion and the second portion.

The crease 114 may be present in both the peelable upper layer 170 and the base layer 160.

The first portion of the base layer 160 is permanently secured to the closure layer by means of a layer of permanent adhesive disposed on the underside of the first portion of the base layer 160. The second portion 164 of the base layer 160 is releasably adhered to the closure layer by means of a layer of resealable adhesive disposed on the underside of the second portion 164 of the base layer 160.

The first portion 172 of the peelable upper layer 170 is secured to the first portion of the base layer 160 by means of a permanent adhesive disposed on the underside of the first portion 172 of the peelable upper layer 170. A layer of permanent adhesive is also disposed on the underside of the second portion 174 of the peelable upper layer 170. The upper surface of the second portion 164 of the base layer 160 is provided with a release coating to thereby cause the second portion 174 of the peelable upper layer 170 to be releasably adhered to the second portion 164 of the base layer 160. It will be appreciated that the second portion 174 of the peelable upper layer 170 could also be releasably adhered to the second portion 164 of the base layer 160 by means of a layer of resealable adhesive disposed on the underside of the second portion 174 of the peelable upper layer 170.

The base layer 160 also includes a finger lift tab 180 to help the user grasp the base layer 160 during use.

FIG. 5 shows the container 100 during use, in which a user has already grasped the peelable upper layer 170, for example via a finger lift tab (not shown), and applied a pulling force to partially remove the peelable upper layer 170 from the base layer 160. This enables the user to view information, such as safety information, that may be printed on both the underside of the peelable upper layer 170 and the upper surface of the base layer 160. The crease 114 prevents the peelable upper layer 170 from snapping back when the peelable upper layer 170 is partially removed from the base layer 160. The user may then grasp the base layer finger lift tab 180 and apply a pulling force to partially remove the base layer 160 from the closure layer to enable access to the contents within the pockets defined in the panel. This also enables the user to view information, such as safety information, that may be printed on the underside of the base layer. The crease 114 is present in both the peelable upper layer 170 and the base layer 160, so the base layer 160 may be prevented from snapping back when the base layer 160 is partially removed from the closure layer.

Once the product has been dispensed, the user may apply pressure to the base layer 160 to readhere the base layer 160 to the closure layer. The peelable upper layer 170 may also be readhered to the base layer 160 by the user applying pressure to the peelable upper layer 170.

The peelable label shown in FIG. 5 may be made by methods known in the art. For example, the base layer may be formed and then the underside and upper surface of the base layer may be printed with information, such as safety information by methods known in the art. A release coating may then be applied to the second portion of the upper surface of the base layer by methods known in the art. The underside and upper surface of the peelable upper layer may be printed with information by methods known in the art. The peelable upper layer may then be married with the base layer, and the first portion of the peelable upper layer may be permanently secured to the first portion of the base layer via a layer of permanent adhesive disposed on the underside of the peelable upper layer. The presence of a layer of release coating disposed on the second portion of the upper surface of the base layer means that the second portion of the peelable upper layer does not permanently adhere to the second portion of the base layer, instead the second portion of the peelable upper layer is releasably adhered to the second portion of the base layer. The peelable label is then applied to the closure layer by methods known in the art.

FIG. 6 shows a further example of a container 100.

The container 100 includes a panel 102, which defines a plurality of pockets (not shown), and a closure layer (not shown), as described above. Adhered to the closure layer is a peelable label. The peelable label is similar to the peelable label shown in FIG. 5; however, the peelable label shown in FIG. 6 includes an additional layer 180. The additional layer 180 is positioned between the peelable upper layer 170 and the base layer 160. The additional layer may be printed, for example with information, on both sides to thereby increase the amount of information displayed within the peelable label. The additional layer includes a first portion (not shown) and a second portion 184. The first and second portions of the additional layer 180 are mutually coextensive with the first and second portions of the peelable upper layer 170 and the base layer 160. The base layer 160, additional layer 180 and peelable upper layer 170 include a hinge in the form of a crease 114 positioned substantially in register with the junction between the first portion and the second portion.

The first portion of the additional layer 180 is permanently secured to the first portion of the base layer 160 and the first portion 172 of the peelable upper layer 170 by means of a layer of permanent adhesive disposed on the underside and the top surface of the first portion of the additional layer 180. It will be appreciated that the layer of permanent adhesive may alternatively be disposed on the underside of the first portion 172 of the peelable upper layer and the upper surface of the first portion of the base layer 160.

The second portion 184 of the additional layer 180 may be releasably adhered to the second portion 164 of the base layer 160 by means of a layer or resealable adhesive disposed on the underside of the second portion 184 of the additional peelable layer 180. The second portion of the additional layer may be releasably adhered to the second portion 174 of the peelable upper layer by means a layer of resealable adhesive disposed on the top surface of the second portion 184 of the additional layer 180. It will be appreciated that the layer of resealable adhesive may alternatively be disposed on the underside of the second portion 174 of the peelable upper layer and on the upper surface of the second portion 164 of the base layer 160.

It will be appreciated that the base layer 160 and the peelable upper layer may alternatively be provided with permanent adhesive, and the additional layer may be provided with a layer of release coating disposed on the underside and the upper surface of the second portion of the additional layer, such that the additional layer is releasably adhered to the base layer and the peelable upper layer.

1. A container comprising:
a panel, defining one or more pockets in the surface thereof,
wherein the one or more pockets are for holding a product;
a closure layer disposed on the panel for sealing the product in the pocket(s); and
a peelable label disposed on the closure layer, the peelable label having a first portion and a second portion,
wherein the first portion of the peelable label is permanently secured to the closure layer or the panel, and the second portion of the peelable label is releasably adhered to the closure layer.

2. A container according to claim 1, wherein the second portion of the peelable label is resealable.

3. A container according to claim 1, wherein the peelable label comprises a hinge substantially in register with the junction between the first portion and the second portion.

4. A container according to claim 3, wherein the peelable label comprises a crease substantially in register with the junction between the first portion and the second portion.

5. A container according to claim 1, wherein the peelable label comprises a laminate having a lower layer and an upper layer.

6. A container according to claim 5, wherein the peelable label comprises a cut in the lower layer substantially in register with the junction between the first portion and the second portion.

7. A container according to claim 1, wherein the first portion of the peelable label is permanently secured to the closure layer or the panel by means of a layer of permanent adhesive disposed on the surface of the first portion.

8. A container according to claim 1, wherein the second portion of the peelable label is releasably adhered to the closure layer by means of a layer of resealable adhesive disposed on the surface of the second portion.

9. A container according to claim 1, wherein the peelable label comprises a finger lift tab.

10. A container according to claim 9, wherein the fingerlift tab is deflected from the plane of the peelable label.

11. A container according to claim 9, wherein the peelable label comprises a dead fold film extending over the fingerlift tab.

12. A container according to claim 1, wherein the peelable label is printed.

13. A container according to claim 12, wherein the underside of the peelable label is printed.

14. A container according to claim 1, wherein the peelable label comprises a base layer and a peelable upper layer, wherein the peelable upper layer is releasably adhered to the base layer, and wherein the base layer comprises a first portion permanently secured to the closure layer or the panel; and a second portion releasably adhered to the closure layer.

15. A container according to claim 14, wherein the peelable upper layer and/or the base layer are printed.

16. A container according to claim 14, wherein the peelable label further comprises one or more additional layers positioned between the base layer and the peelable upper layer.

17. A container according to claim 16, wherein the one or more additional layers positioned between the base layer and the peelable upper layer are adhesive free or comprise an adhesive deadening layer.

18. A container according to claim 14, wherein the peelable label further comprises a folded leaflet adhered to the peelable upper layer or the base layer.

19. A container according to claim 1, wherein the closure layer comprises a foil.

20. A container according to claim 19, wherein the foil is a metallic foil.

21. A container according to claim 1, wherein the one or more pockets are collapsible.

22. A container according to claim 1, wherein the panel defines a plurality of pockets defined therein.

23. A container according to claim 1, wherein the product is a pharmaceutical product.

24-25. (canceled)

26. A container comprising:
a blister pack; and
a peelable label having a first portion and a second portion disposed on the blister pack,
wherein the first portion of the peelable label is permanently secured to the blister pack, and the second portion of the peelable label is releasably adhered to the blister pack.

27. A method for making a container comprising:
forming a blister pack comprising a panel, defining one or more pockets in the surface thereof, wherein the one or more pockets hold a product; and a closure layer disposed on the panel for sealing the product in the one or more pockets;
forming a peelable label having a first portion and a second portion;
adhering the peelable label to the closure layer, such that the first portion is permanently secured to the panel or the closure layer, and the second portion is releasably adhered to the closure layer.

28. A method for making a container according to claim 27, wherein forming the blister pack comprises:
forming a panel, defining one or more pockets in the surface thereof;
dispensing a product in to the one or more pockets;
forming a closure layer;
adhering the closure layer to the panel to thereby seal the product in the pocket(s).

29. (canceled)
